(19) United States
(12) Patent Application Publication
(10) Pub. No.: US 2022/0197684 A1
(43) Pub. Date: Jun. 23, 2022

(54) MONITORING FOR WORKLOADS MANAGED BY A CONTAINER ORCHESTRATOR IN A VIRTUALIZED COMPUTING SYSTEM

(71) Applicant: VMware, Inc., Palo Alto, CA (US)

(72) Inventors: Yash Nitin DESAI, Mountain View, CA (US); Abhishek SRIVASTAVA, Sunnyvale, CA (US); Krishna Chaitanya BANDI, Santa Clara, CA (US)

(21) Appl. No.: 17/132,367

(22) Filed: Dec. 23, 2020

(51) Int. Cl. G06F 9/455

(52) U.S. Cl. CPC G06F 9/45558; G06F 2009/4557; G06F 2009/45575; G06F 2009/45591

(57) ABSTRACT

An example method of application monitoring in a virtualized computing system including a host cluster of having a virtualization layer directly executing on hardware platforms of hosts, the virtualization layer supporting execution of virtual machines (VMs) and integrated with an orchestration control plane includes: receiving, at a pod VM controller, a health monitoring specification, the pod VM controller executing in the virtualization layer external to the VMs; providing, from the pod VM controller to a pod VM agent executing in a pod VM of the VMs, the health monitoring specification, the pod VM including a container engine supporting execution of containers therein; executing, in the pod VM by the pod VM agent, at least one probe of an application executing in one or more of the containers; and returning, from the pod VM agent to the pod VM controller, application health status obtained from the at least one probe.

Applications today are deployed onto a combination of virtual machines (VMs), containers, application services, and more. For deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling.

In a Kubernetes system, containers are grouped into logical unit called “pods” that execute on nodes in a duster (also referred to as “node cluster”). Containers in the same pod share the same resources and network and maintain a degree of isolation from containers in other pods. The pods are distributed across nodes of the cluster. In a typical deployment, a node includes an operating system (OS), such as Linux®, and a container engine executing on top of the OS that supports the containers of the pod. A node can be a physical server or a VM.

Computer virtualization is a technique that involves encapsulating a physical computing machine platform into virtual machine(s) executing under control of virtualization software on a hardware computing platform or “host.” A virtual machine (VM) provides virtual hardware abstractions for processor, memory, storage, and the like to a guest operating system. The virtualization software, also referred to as a “hypervisor,” incudes one or more virtual machine monitors (VMMs) to provide execution environment(s) for the virtual machine(s). VMs allow for greater operating system diversity, isolation, and customization than do containers.

### SUMMARY

In an embodiment, a method of application monitoring in a virtualized computing system including a host cluster of having a virtualization layer directly executing on hardware platforms of hosts, the virtualization layer supporting execution of virtual machines (VMs), the virtualization layer integrated with an orchestration control plane, is described. The method includes: receiving, at a pod VM controller, a health monitoring specification, the pod VM controller executing in the virtualization layer external to the VMs; providing, from the pod VM controller to a pod VM agent executing in a pod VM of the VMs, the health monitoring specification, the pod VM including a container engine supporting execution of containers therein; executing, in the pod VM by the pod VM agent, at least one probe of an application executing in one or more of the containers; and returning, from the pod VM agent to the pod VM controller, application health status obtained from the at least one probe.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a virtualized computing system in which embodiments described herein may be implemented.

FIG. 2 is a block diagram depicting software platform according an embodiment.

FIG. 3 is a block diagram of a supervisor Kubernetes master according to an embodiment.

FIG. 4 is a flow diagram depicting a method of handling application health monitoring at a supervisor Kubernetes master according to an embodiment.

FIG. 5 is a flow diagram depicting a method of handling health monitoring at a host according to an embodiment.

FIG. 6 is a flow diagram depicting a method of application health monitoring in a pod VM according to an embodiment.

### DETAILED DESCRIPTION

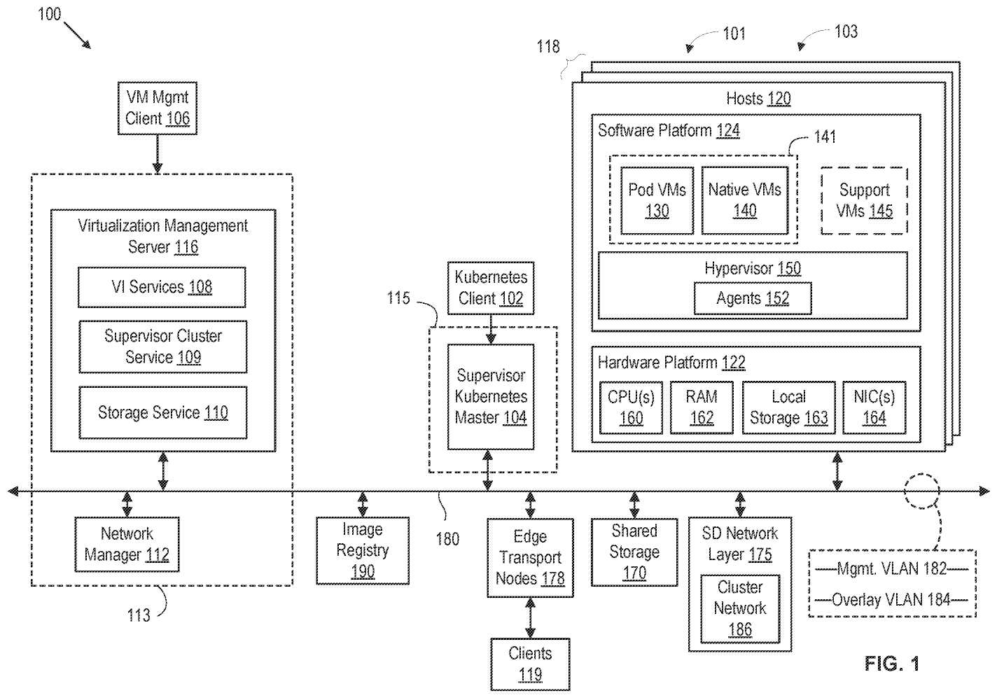

FIG. 1 is a block diagram of a virtualized computing system 100 in which embodiments described herein may be implemented. System 100 includes a cluster of hosts 120 (“host cluster 118”) that may be constructed on server-grade hardware platforms such as an x86 architecture platforms. For purposes of clarity, only one host cluster 118 is shown. However, virtualized computing system 100 can include many of such host clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Physical network 180 can include a plurality of VLANs to provide external network virtualization as described further herein.

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre Channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, Calif.

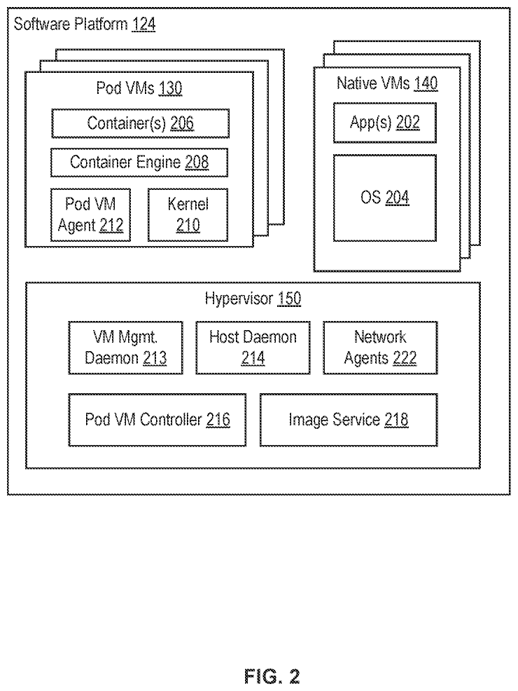

in the example of FIG. 1, host cluster 118 is enabled as a “supervisor cluster,” described further herein, and thus VMs executing on each host 120 include pod VMs 130 and native VMs 140. A pod VM 130 is a virtual machine that includes a kernel and container engine that supports execution of containers, as well as an agent (referred to as a pod VM agent) that cooperates with a controller of an orchestration control plane 115 executing in hypervisor 150 (referred to as a pod VM controller). An example of pod VM 130 is described further below with respect to FIG. 2. VMs 130/140 support applications 141 deployed onto host cluster 118, which can include containerized applications (e.g., executing in either pod VMs 130 or native VMs 140) and applications executing directly on guest operating systems (non-containerized) (e.g., executing in native VMs 140). One specific application discussed further herein is a guest cluster executing as a virtual extension of a supervisor cluster. Some VMs 130/140, shown as support VMs 145, have specific functions within host cluster 118. For example, support VMs 145 can provide control plane functions, edge transport functions, and the like. An embodiment of software platform 124 is discussed further below with respect to FIG. 2.

Host cluster 118 is configured with a software-defined (SD) network layer 175. SD network layer 175 includes logical network services executing on virtualized infrastructure in host cluster 118. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches, logical routers, firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to an external network (e.g., a corporate network, the public Internet, etc.). Edge transport nodes 178 can include a gateway between the internal logical networking of host cluster 118 and the external network. Edge transport nodes 178 can be physical servers or VMs. For example, edge transport nodes 178 can be implemented in support VMs 145 and include a gateway of SD network layer 175. Various clients 119 can access service(s) in virtualized computing system through edge transport nodes 178 (including VM management client 106 and Kubernetes client 102, which as logically shown as being separate by way of example).

Virtualization management server 116 is a physical or virtual server that manages host cluster 118 and the virtualization layer therein. Virtualization management server 116 installs agent(s) 152 in hypervisor 150 to add a host 120 as a managed entity. Virtualization management server 116 logically groups hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118.

In an embodiment, virtualization management server 116 further enables host cluster 118 as a supervisor cluster 101. Virtualization management server 116 installs additional agents 152 in hypervisor 150 to add host 120 to supervisor cluster 101. Supervisor cluster 101 integrates an orchestration control plane 115 with host cluster 118. In embodiments, orchestration control plane 115 includes software components that support a container orchestrator, such as Kubernetes, to deploy and manage applications on host cluster 118. By way of example, a Kubernetes container orchestrator is described herein. In supervisor cluster 101, hosts 120 become nodes of a Kubernetes cluster and pod VMs 130 executing on hosts 120 implement Kubernetes pods. Orchestration control plane 115 includes supervisor Kubernetes master 104 and agents 152 executing in virtualization layer (e.g., hypervisors 150). Supervisor Kubernetes master 104 includes control plane components of Kubernetes, as well as custom controllers, custom plugins, scheduler extender, and the like that extend Kubernetes to interface with virtualization management server 116 and the virtualization layer. For purposes of clarity, supervisor Kubernetes master 104 is shown as a separate logical entity. For practical implementations, supervisor Kubernetes master 104 is implemented as one or more VM(s) 130/140 in host cluster 118. Further, although only one supervisor Kubernetes master 104 is shown, supervisor cluster 101 can include more than one supervisor Kubernetes master 104 in a logical cluster for redundancy and load balancing.

In an embodiment, virtualized computing system 100 further includes a storage service 110 that implements a storage provider in virtualized computing system 100 for container orchestrators. In embodiments, storage service 110 manages lifecycles of storage volumes (e.g., virtual disks) that back persistent volumes used by containerized applications executing in host cluster 118. A container orchestrator such as Kubernetes cooperates with storage service 110 to provide persistent storage for the deployed applications. In the embodiment of FIG. 1, supervisor Kubernetes master 104 cooperates with storage service 110 to deploy and manage persistent storage in the supervisor cluster environment. Other embodiments described below include a vanilla container orchestrator environment and a guest cluster environment. Storage service 110 can execute in virtualization management server 116 as shown or operate independently from virtualization management server 116 (e.g., as an independent physical or virtual server).

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents 152 in hypervisor 150 to add a host 120 as a managed entity, referred to as a transport node. In this manner, host cluster 118 can be a cluster 103 of transport nodes. One example of an SD networking platform that can be configured and used in embodiments described herein as network manager 112 and SD network layer 175 is a VMware NSX® platform made commercially available by VM ware, Inc. of Palo Alto, Calif.

Network manager 112 can deploy one or more transport zones in virtualized computing system 100, including VLAN transport zone(s) and an overlay transport zone. A WAN transport zone spans a set of hosts 120 (e.g., host cluster 118) and is backed by external network virtualization of physical network 180 (e.g., a VLAN). One example VLAN transport zone uses a management VLAN 182 on physical network 180 that enables a management network connecting hosts 120 and the VI control plane (e.g., virtualization management server 116 and network manager 112). An overlay transport zone using overlay VLAN 184 on physical network 180 enables an overlay network that spans a set of hosts 120 (e.g., host cluster 118) and provides internal network virtualization using software components (e.g., the virtualization layer and services executing in VMs). Host-to-host traffic for the overlay transport zone is carried by physical network 180 on the overlay VLAN 184 using layer-2-over-layer-3 tunnels. Network manager 112 can configure SD network layer 175 to provide a cluster network 186 using the overlay network. The overlay transport zone can be extended into at least one of edge transport nodes 178 to provide ingress/egress between cluster network 186 and an external network.

In an embodiment, system 100 further includes an image registry 190. As described herein, containers of supervisor cluster 101 execute in pod VMs 130. The containers in pod VMs 130 are spun up from container images managed by image registry 190. Image registry 190 manages images and image repositories for use in supplying images for containerized applications.

Virtualization management server 116 and network manager 112 comprise a virtual infrastructure (VI) control plane 113 of virtualized computing system 100. Virtualization management server 116 can include a supervisor cluster service 109, storage service 110, and VI services 108. Supervisor cluster service 109 enables host cluster 118 as supervisor cluster 101 and deploys the components of orchestration control plane 115. VI services 108 include various virtualization management services, such as a distributed resource scheduler (DRS), high-availability (HA) service, single sign-on (SSO) service, virtualization management daemon, and the like. DRS is configured to aggregate the resources of host cluster 118 to provide resource pools and enforce resource allocation policies. DRS also provides resource management in the form of load balancing, power management, VM placement, and the like. HA service is configured to pool VMs and hosts into a monitored cluster and, in the event of a failure, restart VMs on alternate hosts in the cluster. A single host is elected as a master, which communicates with the HA service and monitors the state of protected VMs on subordinate hosts. The HA service uses admission control to ensure enough resources are reserved in the cluster for VM recovery when a host fails. SSO service comprises security token service, administration server, directory service, identity management service, and the like configured to implement an SSO platform for authenticating users. The virtualization management daemon is configured to manage objects, such as data centers, clusters, hosts, VMs, resource pools, datastores, and the like.

A VI admin can interact with virtualization management server 116 through a VM management client 106. Through VM management client 106, a VI admin commands virtualization management server 116 to form host cluster 118, configure resource pools, resource allocation policies, and other cluster-level functions, configure storage and networking, enable supervisor cluster 101, deploy and manage image registry 190, and the like.

Kubernetes client 102 represents an input interface for a user to supervisor Kubernetes master 104. Kubernetes client 102 is commonly referred to as kubectl. Through Kubernetes client 102, a user submits desired states of the Kubernetes system, e.g., as YAML documents, to supervisor Kubernetes master 104. In embodiments, the user submits the desired states within the scope of a supervisor namespace. A “supervisor namespace” is a shared abstraction between VI control plane 113 and orchestration control plane 115. Each supervisor namespace provides resource-constrained and authorization-constrained units of multi-tenancy. A supervisor namespace provides resource constraints, user-access constraints, and policies (e.g., storage policies, network policies, etc.). Resource constraints can be expressed as quotas, limits, and the like with respect to compute (CPU and memory), storage, and networking of the virtualized infrastructure (host duster 118, shared storage 170, SD network layer 175). User-access constraints include definitions of users, roles, permissions, bindings of roles to users, and the like. Each supervisor namespace is expressed within orchestration control plane 115 using a namespace native to orchestration control plane 115 (e.g., a Kubernetes namespace or generally a “native namespace”), which allows users to deploy applications in supervisor cluster 101 within the scope of supervisor namespaces. In this manner, the user interacts with supervisor Kubernetes master 104 to deploy applications in supervisor cluster 101 within defined supervisor namespaces.

While FIG. 1 shows an example of a supervisor duster 101, the techniques described herein do not require a supervisor cluster 101. In some embodiments, host cluster 118 is not enabled as a supervisor cluster 101. In such case, supervisor Kubernetes master 104, Kubernetes client 102, pod VMs 130, supervisor cluster service 109, and image registry 190 can be omitted. While host cluster 118 is show as being enabled as a transport node duster 103 in other embodiments network manager 112 can be omitted. In such case, virtualization management server 116 functions to configure SD network layer 175.

FIG. 2 is a block diagram depicting software platform 124 according an embodiment. As described above, software platform 124 of host 120 includes hypervisor 150 that supports execution of VMs, such as pod VMs 130, native VMs 140, and support VMs 145. In an embodiment, hypervisor 150 includes a VM management daemon 213, a host daemon 214, a pod VM controller 216, an image service 218, and network agents 222. VM management daemon 213 is an agent 152 installed by virtualization management server 116. VM management daemon 213 provides an interface to host daemon 214 for virtualization management server 116. Host daemon 214 is configured to create, configure, and remove VMs (e.g., pod VMs 130 and native VMs 140).

Pod VM controller 216 is an agent 152 of orchestration control plane 115 for supervisor cluster 101 and allows supervisor Kubernetes master 104 to interact with hypervisor 150. Pod VM controller 216 configures the respective host as a node in supervisor cluster 101. Pod VM controller 216 manages the lifecycle of pod VMs 130, such as determining when to spin-up or delete a pod VM. Pod VM controller 216 also ensures that any pod dependencies, such as container images, networks, and volumes are available and correctly configured. Pod VM controller 216 is omitted if host cluster 118 is not enabled as a supervisor cluster 101.

Image service 218 is configured to pull container images from image registry 190 and store them in shared storage 170 such that the container images can be mounted by pod VMs 130. Image service 218 is also responsible for managing the storage available for container images within shared storage 170. This includes managing authentication with image registry 190, assuring providence of container images by verifying signatures, updating container images when necessary, and garbage collecting unused container images. Image service 218 communicates with pod VM controller 216 during spin-up and configuration of pod VMs 130. In some embodiments, image service 218 is part of pod VM controller 216. In embodiments, image service 218 utilizes system VMs 130/140 in support VMs 145 to fetch images, convert images to container image virtual disks, and cache container image virtual disks in shared storage 170.

Network agents 222 comprises agents 152 installed by network manager 112. Network agents 222 are configured to cooperate with network manager 112 to implement logical network services. Network agents 222 configure the respective host as a transport node in a cluster 103 of transport nodes.

Each pod VM 130 has one or more containers 206 running therein in an execution space managed by container engine 208. The lifecycle of containers 206 is managed by pod VM agent 212. Both container engine 208 and pod VM agent 212 execute on top of a kernel 210 (e.g., a Linux® kernel). Each native VM 140 has applications 202 running therein on top of an OS 204. Native VMs 140 do not include pod VM agents and are isolated from pod VM controller 216. Container engine 208 can be an industry-standard container engine, such as libcontainer, runc, or containerd. Pod VMs 130, pod VM controller 216, and image service 218 are omitted if host cluster 118 is not enabled as a supervisor cluster 101.

Workload management software, such as Kubernetes, allows running probes to monitor and report the health of deployed workloads (e.g., containerized applications). In addition, workload management software, such as Kubernetes, allows for remediation based on health of deployed workloads (e.g., containerized applications), such as restarting the application. In embodiments, orchestration control plane 115 includes health monitoring and remediation, which is extended for operation with pod VMs, which as described above include containerized application executing therein. In embodiments, health monitoring and remediation is performed using pod VM agent 212, which may cooperate with pod VM controller 216. In turn, pod VM controller 216 may cooperate with supervisor Kubernetes master 104.

When a user requests an application to be deployed, orchestration control plane 115 schedules the application to be run on an appropriate node (e.g., an appropriate host 120 in cluster 118. Orchestration control plane 115 deploys and boots a pod VM 130 on the selected host 120 and starts pod VM agent 212. Pod VM agent 212 establishes a channel with pod VM controller 216, which can be a private hypervisor-to-guest communication channel. Pod VM controller 216 obtains information describing probes to be run from supervisor Kubernetes master 104 and forwards this information to pod VM agent 212 over the hypervisor-to-guest channel. Pod VM agent 212 then executes the probes to monitor the containerized application(s). The pod VM agent 212 can return health information to pod VM controller 216 over the hypervisor-to-guest channel (e.g., application status). Pod VM controller 216 can then relay this health information to supervisor Kubernetes master 104 in an application health report.

in embodiments, pod VM agent 212 is configured to start and monitor the health of the various processes within an application and run all the probes in pod VM 130, periodically, as per each probe's period. Depending on the type of the request probe, pod VM agent 212 will executes a new process within the application, performs a network request against the application's IP and port, or performs a network open port, check against the application's IP and port. In case application or probe failure, pod VM agent 212 remediates by restarting the application, if such a restart is specified by the user. Pod VM agent 212 assimilate the total health status report for the application and provides the health report to pod VM controller 212 when requested. Pod VM controller 216 reports back the status for all the applications running on a host 120 to supervisor Kubernetes master 104. Monitoring the health of the application in pod VM 130 also makes it possible to perform smarter actions to manage the workload more efficiently. For example, pod VM controller 216 can power-off pod VM 130 when am application has completed or hot-add CPU resources in case of increased demand, or kick in a memory balloon driver When an application is taking up too much memory.

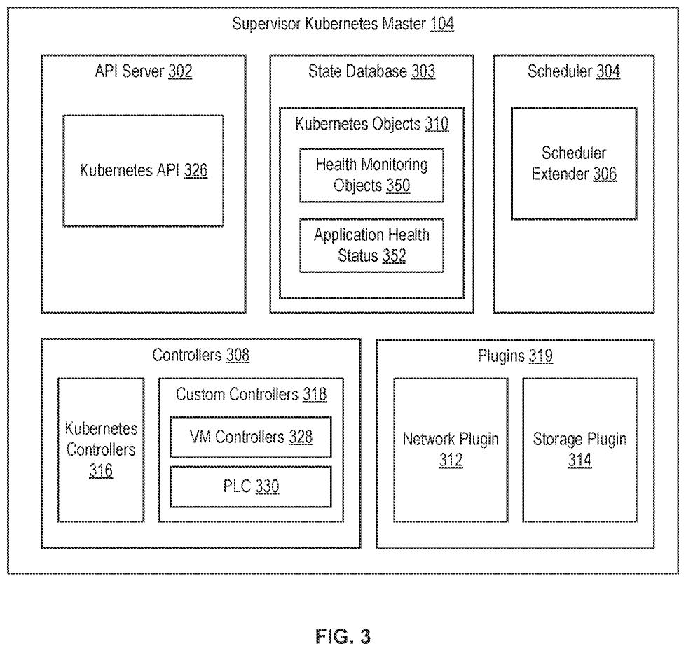

FIG. 3 is a block diagram of supervisor Kubernetes master 104 according to an embodiment. Supervisor Kubernetes master 104 includes application programming interface (API) server 302, a state database 303, a scheduler 304, a scheduler extender 306, controllers 308, and plugins 319. API server 302 includes the Kubernetes API server, kube-api-server (“Kubernetes API 326”).

State database 303 stores the state of supervisor cluster 101 (e.g., etcd) as objects created by API server 302. A user can provide application specification data to API server 302 that defines various objects supported by the API (e.g., as a YAML document). The objects have specifications that represent the desired state. State database 303 stores the objects defined by application specification data as part of the supervisor cluster state. Standard Kubernetes objects (“Kubernetes Objects 310”) include namespaces, nodes, pods, config maps, secrets, among others.

Namespaces provide scope for objects. Namespaces are objects themselves maintained in state database 303. A namespace can include resource quotas, limit ranges, role bindings, and the like that are applied to objects declared within its scope. VI control plane 113 creates and manages supervisor namespaces for supervisor cluster 101. A supervisor namespace is a resource-constrained and authorization-constrained unit of multi-tenancy managed by virtualization management server 116. Namespaces inherit constraints from corresponding supervisor cluster namespaces. Config maps include configuration information for applications managed by supervisor Kubernetes master 104. Secrets include sensitive information for use by applications managed by supervisor Kubernetes master 104 (e.g., passwords, keys, tokens, etc.). The configuration information and the secret information stored by config maps and secrets is generally referred to herein as decoupled information. Decoupled information is information needed by the managed applications, but which is decoupled from the application code.

In embodiments, users specify health monitoring objects 350 that define probes for monitoring applications and remediation actions depending on health state. In addition, state database 303 can store application health status 352, which includes health report information returned to supervisor Kubernetes master 104 from pod VM controllers 216 in hosts 120.

Controllers 308 can include, for example, standard Kubernetes controllers (“Kubernetes controllers 316”) (e.g., kube-controller-manager controllers, cloud-controller-manager controllers, etc.) and custom controllers 318. Custom controllers 318 include controllers for managing lifecycle of Kubernetes objects 310 and custom objects. For example, custom controllers 318 can include a VM controllers 328 configured to manage VM objects and a pod VM lifecycle controller (PLC) 330 configured to manage pods. A controller 308 tracks objects in state database 303 of at least one resource type. Controller(s) 318 are responsible for making the current state of supervisor cluster 101 come closer to the desired state as stored in state database 303. A controller 318 can carry out action(s) by itself, send messages to API server 302 to have side effects, and/or interact with external systems.

Plugins 319 can include, for example, network plugin 312 and storage plugin 314. Plugins 319 provide a well-defined interface to replace a set of functionality of the Kubernetes control plane. Network plugin 312 is responsible for configuration of SD network layer 175 to deploy and configure the cluster network. Network plugin 312 cooperates with virtualization management server 116 and/or or network manager 112 to deploy logical network services of the cluster network. Network plugin 312 also monitors state database for custom objects 307, such as NIFobjects. Storage plugin 314 is responsible for providing a standardized interface for persistent storage lifecycle and management to satisfy the needs of resources requiring persistent storage. Storage plugin 314 cooperates with virtualization management server 116 and/or persistent storage manager 110 to implement the appropriate persistent storage volumes in shared storage 170.

Scheduler 304 watches state database 303 for newly created pods with no assigned node. A pod is an object supported by API server 302 that is a group of one or more containers, with network and storage, and a specification on how to execute. Scheduler 304 selects candidate nodes in supervisor cluster 101 for pods. Scheduler 304 cooperates with scheduler extender 306, which interfaces with virtualization management server 116. Scheduler extender 306 cooperates with virtualization management server 116 (e.g., such as with DRS) to select nodes from candidate sets of nodes and provide identities of hosts 120 corresponding to the selected nodes. For each pod, scheduler 304 also converts the pod specification to a pod VM specification, and scheduler extender 306 asks virtualization management server 116 to reserve a pod VM on the selected host 120. Scheduler 304 updates pods in state database 303 with host identifiers.

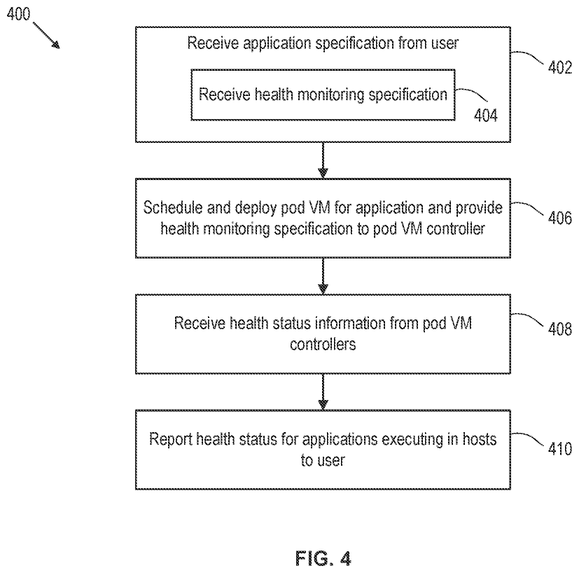

FIG. 4 is a flow diagram depicting a method 400 of handling application health monitoring at supervisor Kubernetes master 104 according to an embodiment. Method 400 begins at step 402, where supervisor Kubernetes master 104 receives an application specification from a user. The application specification includes information for deploying one or more containerized applications on a node. At step 404, supervisor Kubernetes master 104 receives health monitoring specification as part of the application specification. The health monitoring specification includes information for health monitoring probes and remediation operations. Health monitoring probes can be of various specified types, such as executing a monitoring process in an application, performing a network request against an application's IP and port, performing a network open port check against an application's IP and port, and the like. Remediation operations include restarting an application, powering off a pod VM 130, hot-adding resources (e.g., CPU, memory, etc.), enabling hypervisor features (e.g., adding a memory balloon driver), and the like.

At step 406, supervisor Kubernetes master 104 schedules and deploys a pod VM 130 on a host 120 for the application as specified and provides the health monitoring specification to pod VM controller 216 in host 120. As discussed herein, pod VM controller 216 cooperates with pod VM agent 212 to implement the health monitoring and remediation operations as specified. At step 408, supervisor Kubernetes master 104 receives health status information from one or more pod VM controllers 216 in cluster 118. Health status information includes information related to application execution. At step 410, supervisor Kubernetes master 104 reports health status for applications executing in hosts 120 to a user.

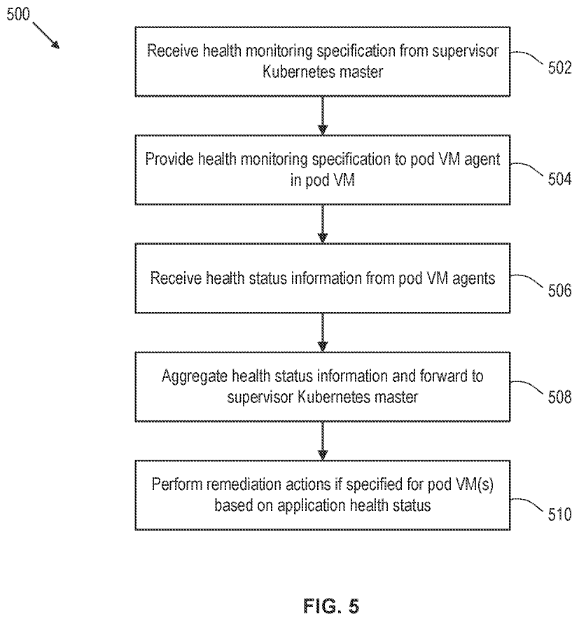

FIG. 5 is a flow diagram depicting a method 500 of handling health monitoring at a host 120 according to an embodiment. Method 500 begins at step 502, where pod VM controller 216 receives a health monitoring specification for an application from supervisor Kubernetes master 104. At step 504, pod VM controller 216 provides the health monitoring specification to pod VM agent 212 in pod VM 130. Pod VM agent 212 is configured to perform health monitoring based on the specification and to report status back to pod VM controller 216. At step 506, pod VM controller 216 receives health status information from pod VM agents 212 executing in pod VMs 130. At step 508, pod VM controller 216 aggregates health status information from one or more pod VMs 130 and forwards the health status information as a report to supervisor Kubernetes master 104. At step 510, pod VM controller 216 performs remediation actions if specified for one or more pod VMs based on application health status. For example, pod VM controller 216 can cooperate with pod VM agent 212 to restart an application. In another example, pod VM controller 216 can restart or shut down a pod VM 130.

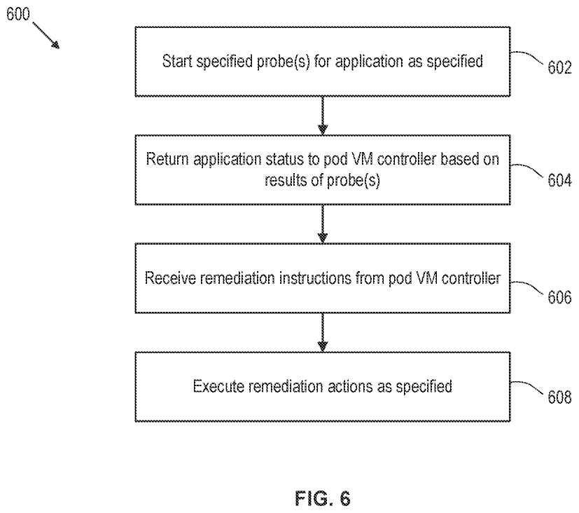

FIG. 6 is a flow diagram depicting a method 600 of application health monitoring in a pod VM according to an embodiment. Method 600 begins at step 602, where pod VM agent 212 starts specified probe(s) for an application. The probe(s) can be of various types, such as a process executing alongside the application that monitors application status; a network request against an application's IP and specified port; a network port check against an application's IP and specified port; and the like. Each probe can be executed periodically as specified, one time as specified, or some number of times as specified. At step 604, pod VM agent 212 returns application health status to pod VM controller 216 based on the results of probe(s). At step 606, pod VM agent 212 receives remediation instructions from pod VM controller 216 if specified. For example, pod VM agent 212 can receive instructions to restart the application if probe(s) reveal a particular application state. In another example, pod VM agent 212 can terminate all application processes if pod VM 130 is to be restarted or shut down by pod VM controller 216. At step 608, pod VM agent 212 executes any remediation actions as specified.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of application monitoring in a virtualized computing system including a host cluster of having a virtualization layer directly executing on hardware platforms of hosts, the virtualization layer supporting execution of virtual machines (VMs), the virtualization layer integrated with an orchestration control plane, the method comprising:
receiving, at a pod VM controller, a health monitoring specification, the pod VM controller executing in the virtualization layer external to the VMs;
providing, from the pod VM controller to a pod VM agent executing in a pod VM of the VMs, the health monitoring specification, the pod VM including a container engine supporting execution of containers therein;
executing, in the pod VM by the pod VM agent, at least one probe of an application executing in one or more of the containers; and
returning, from the pod VM agent to the pod VM controller, application health status obtained from the at least one probe.

2. The method of claim 1, further comprising:
receiving, at the pod VM controller from a master server of the orchestration control plane, the health monitoring specification.

3. The method of claim 2, further comprising:
sending, from the pod VM controller to the master server, the application health status.

4. The method of claim 1, wherein the at least one probe comprises at least one of: a process executing alongside the application in the one or more containers; a network request against an internet protocol (IP) address of the application and a port; or a network port check against the IP address of the application and the port.

5. The method of claim 1, wherein the health monitoring specification includes at least one remediation action, the method further comprising:
executing, by the pod VM agent, the at least one remediation action in response to the application health status matching a specified status.

6. The method of claim 5, wherein the at least one remediation action includes restarting the application.

7. The method of claim 1, wherein the health monitoring specification includes at least one remediation action, the method further comprising:
executing, by the pod VM controller, the at least one remediation action in response to the application health status matching a specified status.

8. A non-transitory computer readable medium comprising instructions to be executed in a computing device to cause the computing device to carry out a method of application monitoring in a virtualized computing system including a host cluster of having a virtualization layer directly executing on hardware platforms of hosts, the virtualization layer supporting execution of virtual machines (VMs), the virtualization layer integrated with an orchestration control plane, the method comprising:
receiving, at a pod VM controller, a health monitoring specification, the pod VM controller executing in the virtualization layer external to the VMs;
providing, from the pod VM controller to a pod VM agent executing in a pod VM of the VMs, the health monitoring specification, the pod VM including a container engine supporting execution of containers therein;
executing, in the pod VM by the pod VM agent, at least one probe of an application executing in one or more of the containers; and
returning, from the pod VM agent to the pod VM controller, application health status obtained from the at least one probe.

9. The non-transitory computer readable medium of claim 8, further comprising:
receiving, at the pod VM controller from a master server of the orchestration control plane, the health monitoring specification.

10. The non-transitory computer readable medium of claim 9, further comprising:
sending, from the pod VM controller to the master server, the application health status.

11. The non-transitory computer readable medium of claim 8, wherein the at least one probe comprises at least one of: a process executing alongside the application in the one or more containers; a network request against an internet protocol (IP) address of the application and a port; or a network port check against the IP address of the application and the port.

12. The non-transitory computer readable medium of claim 8, wherein the health monitoring specification includes at least one remediation action, the method further comprising:
executing, by the pod VM agent, the at least one remediation action in response to the application health status matching a specified status.

13. The non-transitory computer readable medium of claim 12, wherein the at least one remediation action includes restarting the application.

14. The non-transitory computer readable medium of claim 8, wherein the health monitoring specification includes at least one remediation action, the method further comprising:
executing, by the pod VM controller, the at least one remediation action in response to the application health status matching a specified status.

15. A virtualized computing system, comprising:
a host cluster having a virtualization layer executing on hardware platforms of hosts, the virtualization layer supporting executing of virtual machines (VMs), the virtualization layer integrated with an orchestration control plane;
a pod VM of the VMs, the pod VM including a container engine supporting execution of containers therein;
a pod VM controller executing in the virtualization layer of a host external to the VMs; and
a pod VM agent executing in the pod VM;
wherein the pod VM controller receives a health monitoring specification and provides the health monitoring specification to the pod VM agent;
wherein the pod VM agent executes at least one probe of an application executing in one or more of the containers and returns application health status obtained from the at least one probe to the pod VM controller.

16. The virtualized computing system of claim 15, wherein the pod VM controller is configured to receive the health monitoring specification from a master server of the orchestration control plane.

17. The virtualized computing system of claim 16, wherein the pod VM controller is configured to send the application health status to the master server.

18. The virtualized computing system of claim 15, wherein the at least one probe comprises at least one of: a process executing alongside the application in the one or more containers; a network request against an internet protocol (IP) address of the application and a port; or a network port check against the IP address of the application and the port.

19. The virtualized computing system of claim 15, wherein the health monitoring specification includes at least one remediation action, and wherein the pod VM agent executes the at least one remediation action in response to the application health status matching a specified status.

20. The virtualized computing system of claim 15, wherein the health monitoring specification includes at least one remediation action, and wherein the pod VM controller executes the at least one remediation action in response to the application health status matching a specified status.
